(19) United States
(12) Patent Application Publication
(10) Pub. No.: US 2016/0271748 A1
(43) Pub. Date: Sep. 22, 2016

(54) HANDHELD OR SEMISTATIONARY MACHINE TOOL OR WORK TOOL

(71) Applicant: HILTI AKTIENGESELLSCHAFT, Schaan (LI)

(72) Inventors: Uwe Gerold, Lindau (DE); Marc Barrafon Gomez, Oberriet (CH); Norbert Welte, Klaus (AT); Mario Grazioli, Chur (CH)

(21) Appl. No.: 15/028,766

(22) PCT Filed: Oct. 21, 2014
(86) PCT No.: PCT/EP2014/072496

§ 371 Date: Apr. 12, 2016

(30) Foreign Application Priority Data
Oct. 29, 2013 (EP) 13190634.9

(51) Int. Cl. B23Q 17/00; B23Q 17/12; H04R 1/02; B25F 5/00

(52) U.S. Cl. CPC B23Q 17/008; B25F 5/00; B23Q 17/12; H04R 1/028

(57) ABSTRACT

The invention relates to a handheld or semistationary machine tool or work tool, having a housing in which there is arranged at least one mechanical actuating device which emits noise, for example in the form of structure-borne sound, during operation of the machine tool or work tool. In order to further simplify the operation of handheld or semistationary machine tools or work tools and/or to increase the service intervals or lifetime thereof, the machine tool or work tool comprises at least one device for sensing noise that occurs during operation of the machine tool or work tool.

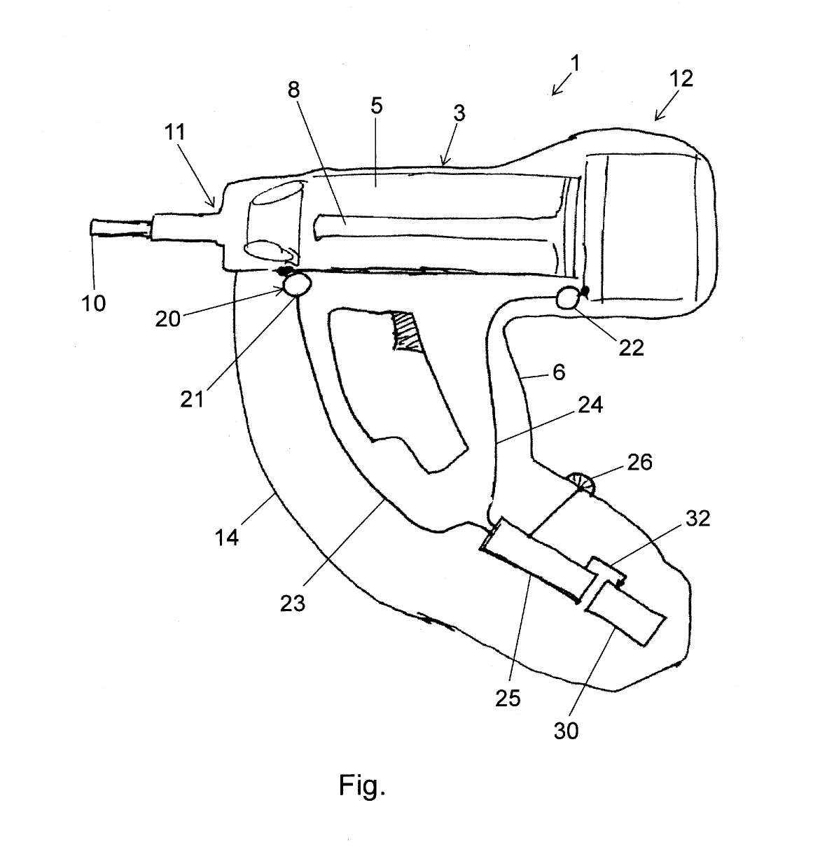

### TECHNICAL FIELD

The invention relates to a handheld or semistationary power tool or work tool, having a housing in which at least one mechanical actuating device is arranged that emits noises, e.g. in the form of structure-borne sound, during operation of the power tool or work tool. The invention further relates to a method for operating such a power tool or work tool.

### PRIOR ART

The handheld tool can be a handheld driving tool, for example, as disclosed in German Patent Application No. DE 10 2006 000 517 A1 and DE 10 2006 035 460 A1. The power tool or work tool can also be a handheld tool as described in German Patent No. DE 33 10 371 C1.

German Patent Application No. DE 101 56 218 A1 discloses a handheld or semistationary electric power tool having a device for storing machine-related data and a device for detecting load states during operation of the electric power tool and for converting the determined load states into load data that can be stored in the storage device, wherein an internal or external processor-controlled device is used for processing the load data in order to obtain a service prediction and a prediction of the remaining malfunction-free operating period or to output a fault message.

### PRESENTATION OF THE INVENTION

The problem addressed by the invention is that of further simplifying the operation of handheld or semistationary power tools or work tools and/or extending the service intervals or service life thereof.

For a handheld or semistationary power tool or work tool, having a housing in which at least one mechanical actuating device is arranged that emits noises, e.g. in the form of structure-borne sound, during operation of the power tool or work tool, the problem is solved in that the power tool comprises at least one device for detecting noises that occur during operation of the power tool or work tool. According to an essential aspect of the invention, acoustic monitoring of the handheld or semistationary power tool or work tool is enabled by detecting noises, more particularly sound signals, at one or more selected points. Thereby incipient damage to tool components can be reliably detected, independently of a user.

One preferred embodiment of the handheld or semistationary power tool or work tool is characterized in that the device for detecting noises occurring during operation of the power tool or work tool comprises at least one microphone. The microphone is preferably a small component that can be accommodated without problems in an existing housing of the handheld or semistationary power tool or work tool.

Another preferred embodiment of the handheld or semistationary power tool or work tool is characterized in that the device for detecting noises occurring during operation of the power tool or work tool comprises at least one force sensor and/or vibration sensor and/or strain sensor. The force sensor and/or the vibration sensor and/or the strain sensor is preferably arranged in or on the housing such that the noises, more particularly the sound signals, can be detected directly at or in the vicinity of their place of origin. In this way, even small changes, particularly changes of operating noises, can be detected quickly and securely.

Another preferred embodiment of the handheld or semistationary power tool or work tool is characterized by providing, at different points in or on the housing, a plurality of devices for detecting noises occurring during operation of the power tool or work tool. The different points can be determined with the aid of relatively simple measurements during operation of the handheld or semistationary power tool or work tool.

Another preferred embodiment of the handheld or semistationary power tool or work tool is characterized in that a device for detecting noises occurring during operation of the power tool or work tool is arranged in an anterior/posterior region of the power tool or work tool. The fastener driving tool, for example. A fastener driving tool comprises a mechanical tappet to which a relatively large force is applied suddenly in a posterior end region of the fastener driving tool, for example. The tappet outputs the force, or the acceleration, in the anterior region of the fastener driving tool to a pin or a nail, which exits from a bolt-setting end of the fastener driving tool with the aid of the tappet and is driven into an underlying surface.

Another preferred embodiment of the handheld or semistationary power tool or work tool is characterized in that the power tool or work tool is designed as a nailer, a handheld driving tool or a fastener driving tool. The fastener driving tool be can be a fuel-operated, pneumatically driven or electrically driven fastener driving tool.

In a method for operating a handheld or semistationary power tool or work tool as described previously, the above-mentioned problem is solved alternatively or additionally by evaluating the noises detected with the device during operation of the power tool or working tool and using the result in order to identify damage to tool components, for example. Undesirable consequential damage can be prevented in this way.

A preferred embodiment of the method is characterized in that multiple tool components are monitored simultaneously. Multiple tool components, which can generate different noises during operation of the power tool or work tool, can advantageously be monitored with one microphone.

Another preferred embodiment of the method is characterized in that information regarding a malfunction of the power tool or work tool is immediately displayed to a user during operation of the power tool or work tool. The relevant information is advantageously displayed visually. A corresponding display device is mounted on the exterior of the power tool or work tool housing, for example.

Another preferred embodiment of the method is characterized in that the power tool is deactivated if a significant malfunction is detected during operation of the power tool or work tool. In a simple manner, this prevents further use of a power tool or work tool after the occurrence of a malfunction.

Other advantages, features, and details of the invention can be deduced from the following description, in which various embodiments are described in detail with reference to the drawing.

The sole appended FIGURE shows a simplified representation of a power tool or work tool according to the invention in a longitudinal section.

### EMBODIMENTS

The sole appended FIGURE shows a simplified longitudinal sectional view of a power tool or work tool 1 having a housing 5 and a handle 6. The power tool or work tool 1 is an electrically driven fastener driving tool 3. The invention is also applicable to fuel-operated or pneumatically driven fastener driving tools, however. Furthermore, the invention can be used in other power tools or work tools such as drills.

The fastener driving tool 3 is used for driving fastening elements into an underlying surface (not shown). The fastening elements are subjected to a relatively large force and accelerated in the housing 5 with the aid of a mechanical actuating device 8. The fastening elements subjected to force and accelerated in this manner exit from the housing 5 at a setting end 10.

The fastening elements used are provided via an internal magazine 14 that is mounted in the vicinity of the setting end 10 of the power tool or work tool 1. The fastening elements are preferably removed automatically and individually from the magazine 14 and provided at the setting end 10.

The energy required for driving the fastening elements into the underlying surface is output via the mechanical actuating device 8 to the respective fastening element in an anterior end 11 of the housing 5. The energy required for driving the fastening element into the underlying surface is provided electrically, for example, in a posterior region 12 of the housing 5.

Alternatively, the energy required for driving the fastening elements into the underlying surface can be provided in a fuel container in the posterior region 12. In addition, the energy required for driving the fastening elements into the underlying surface can be provided pneumatically.

The power tool or work tool 1 according to the invention comprises a device 20 for detecting noises, in the form of structure-borne sound for example, that occur during operation of the power tool or work tool 1. The noise-detecting device 20 comprises a microphone 21 and a microphone 22.

The microphone 21 is arranged in an anterior region 11 of the fastener driving tool 3. The microphone 21 is arranged in the vicinity of an anterior end of a tappet of the mechanical actuating device 8. The microphone 22 is arranged in a posterior region 12 of the fastener driving tool 3. The microphone 22 is arranged in the vicinity of the posterior end of the tappet of the mechanical actuating device 8.

The microphone 21 is connected via a line 23 to an evaluation unit 25. The microphone 22 is connected via a line 24 to the evaluation unit 25. Sound signals in the anterior region 11 and the posterior region 12 of the fastener driving tool 3 are detected with the microphones 21 and 22. These sound signals are evaluated in the central evaluation unit 25.

The central evaluation unit 25 is accommodated together with a controller 30 in a lower end of the handle 6 of the fastener driving tool 3. The evaluation unit 25 is operated with software that is permanently specified on a tool-dependent basis. The software is used to define the parameters necessary for the operation of a defined tool type. This provides the advantage that an individual training phase for the respective tool type can be dispensed with.

A malfunction in the operation of the fastener driving tool 3 can be detected by means of the evaluation unit 25 with the aid of the microphones 21 and 22. The detected malfunction is directly displayed to a user of the fastener driving tool 3 via a display device 26. The information that a malfunction exists can alternatively or additionally be transmitted acoustically to the user, via suitable warning tones for example. The display device 26 is connected via a line to the central evaluation unit 25.

The controller 30 is also connected to the evaluation device 25 via a signal line 32. The fastener driving tool 3 can also be automatically deactivated via the signal line 32 and the controller 30 in the event of a significant malfunction. In a simple manner, this prevents further use of the fastener driving tool 3 if there is a significant malfunction.

The invention offers the advantage, among others, that the circuitry expense is relatively low. The central evaluation unit 25 can accordingly be constructed very compactly. The small dimensions of the evaluation unit 25 enable integration into the housing 5 in a simple manner. It is also advantageously possible to forgo external modules or connection cables. An appropriate evaluation program allows a reliable differentiation between differences in handling and genuine or significant malfunctions during operation of the fastener driving tool 3.

1. A handheld or semistationary power tool or work tool comprising a housing having arranged therein at least one mechanical actuating device that emits noises during operation of the tool, wherein the tool further comprises at least one device for detecting the noises.

2. The tool according to claim 1, wherein the device for detecting the noises comprises at least one force sensor and/or vibration sensor and/or strain sensor.

3. The tool according to claim 1, wherein the device for detecting the noises comprises at least one microphone.

4. The tool according to claim 1, comprising a plurality of devices for detecting the noises, arranged at different locations in or on the housing.

5. The tool according to claim 1, wherein the device for detecting the noises is arranged in an anterior region or in a posterior region of the tool.

6. The tool according to claim 1, comprising a nailer, a handheld driving tool or a fastener driving tool.

7. A method for operating the handheld or semistationary power tool or work tool according to claim 1, the method comprising detecting the noises during operation of the tool and evaluating the noises in order to identify damage to tool components.

8. The method according to claim 7, comprising monitoring multiple tool components simultaneously.

9. The method according to claim 7, including immediately displaying information regarding a malfunction during operation of the tool to a user during operation of the tool.

10. The method according to claim 7, including deactivating the tool if a significant malfunction is detected during operation of the tool.

11. The tool according to claim 1, wherein the noises are structure-borne sound.

12. The tool according to claim 2, wherein the device for detecting the noises comprises at least one microphone.

13. The tool according to claim 2, comprising a plurality of devices for detecting the noises, arranged at different locations in or on the housing.

14. The tool according to claim 3, comprising a plurality of devices for detecting the noises, arranged at different locations in or on the housing.

15. The tool according to claim 12, comprising a plurality of devices for detecting the noises, arranged at different locations in or on the housing.

16. The tool according to claim 2, wherein the device for detecting the noises is arranged in an anterior region or in a posterior region of the tool.

17. The tool according to claim 3, wherein the device for detecting the noises is arranged in an anterior region or in a posterior region of the tool.

18. The tool according to claim 4, wherein the device for detecting the noises is arranged in an anterior region or in a posterior region of the tool.

19. The tool according to claim 12, wherein the device for detecting the noises is arranged in an anterior region or in a posterior region of the tool.

20. The tool according to claim 13, wherein the device for detecting the noises is arranged in an anterior region or in a posterior region of the tool.
